(19) United States
(12) Patent Application Publication
(10) Pub. No.: US 2008/0185061 A1
(43) Pub. Date: Aug. 7, 2008

(54) RUBBER, TWO-SHOT OVER-MOLD DRAIN GROMMET FOR VEHICLE AIR CONDITIONER

(75) Inventors: Brandon C. Fisk, Clarkston, MI (US); Jason R. Hendry, Milford, MI (US)

Correspondence Address: HARNESS, DICKEY & PIERCE, P.L.C., P.O. BOX 828, BLOOMFIELD HILLS, MI, 48303, US

(73) Assignee: DENSO INTERNATIONAL AMERICA, INC., Southfield, MI (US)

(21) Appl. No.: 11/669,984

(22) Filed: Feb. 1, 2007

(51) Int. Cl. F16K 15/14

(52) U.S. Cl. 137/846

(57) ABSTRACT

A drain grommet includes a grommet body and a seal assembly which are produced using a two-shot over-mold process. The seal assembly includes an outer seal lip which extends radially outward from the grommet body and a duckbill seal which is disposed within an inner diameter defined by the grommet body.

### FIELD

The present disclosure relates to drain grommets for a vehicle air conditioner. More particularly, the present invention relates to a drain grommet which is a two-shot over-mold component which improves the assembly of the drain grommet to the vehicle as well as improving the performance of the drain grommet.

### BACKGROUND

The statements in this section merely provide background information related to the present disclosure and may not constitute prior art.

Vehicle air conditioning systems typically include a compressor located in the engine compartment of a vehicle which compresses refrigerant and delivers the refrigerant to a condenser. The condenser is also located in the engine compartment to condense the gaseous refrigerant supplied by the compressor. The liquid refrigerant is delivered to an expansion device which lowers the pressure of the refrigerant. The lower pressurized refrigerant is delivered to an evaporator which evaporates the liquid refrigerant and in doing so the evaporator cools air being blown into a passenger compartment. The evaporated refrigerant is supplied to the compressor which again compresses the refrigerant and the cycle continues.

The evaporator is typically disposed within the passenger compartment of the vehicle inside an air conditioning case. As the evaporator cools the blown air, moisture will condense onto the evaporator and flow via gravity to the lower portion of the air conditioning case. A drain is provided in the air conditioning case and the condensed water is routed from the drain in the air conditioning case through a drain tube to a position outside of the vehicle where it is discarded. In order to reach the outside of the vehicle, the drain tube must pass through one of the vehicle body portions that form the passenger compartment. A drain grommet is typically attached to the vehicle body portion to extend through a hole in the vehicle body portion to the outside of the vehicle. The drain tube is attached to the drain grommet.

A prior art drain grommet 110 is illustrated in FIGS. 6 and 7. Drain grommet 110 is a three piece assembled component which comprises a plastic grommet body 112, a foam seal 114 and a duckbill outlet 116. Plastic grommet body 112 defines an inlet 118 to which the drain tube is connected, an outlet 120 to which duckbill outlet 116 is attached, a plurality of retaining snaps 122 and a plurality of guiding tabs 124. Foam seal 114 is glued or otherwise secured to grommet body 112 and duckbill outlet 116 is attached to outlet 120 of grommet body 112. This assembly is assembled into the vehicle by attaching the drain pipe to inlet 118 and then pushing drain grommet 110 into a hole in the vehicle body. During assembly, retaining snaps 122 deflect inwardly until hooks 126 pass through the hole. Once through the hole, retaining snaps 122 spring back to their original shape such that hooks 126 retain drain grommet 11 0 in the hole.

While the prior art drain grommets have been performing well in the vehicles, they are not without problems. Duckbill outlet 116 extends a significant distance above grommet body 112 causing it to interfere with other vehicle components. Foam seal 114 is a soft semi-closed foam which may deteriorate over time and may come loose from grommet body 112 over time. In addition, because it is a soft foam, it is possible to tear it during assembly. All of these issues with foam seal 114 will lead to water leaking. Also, because of the multiple retaining snaps 122 and the multiple guiding tabs 124, it is possible to misalign drain grommet 110 with the hole in the vehicle body leading to an improper assembly. Finally, due to the circumferential size of each retaining snap 122, installation force can be greater than what is desired.

### SUMMARY

The present disclosure provides a drain grommet which is a single piece two-shot over-molded component which resolves the problems associated with the prior art drain grommets. Because of the two-shot over-molded process, the duckbill outlet can be reduced in height and the foam seal can be replaced by a molded elastomeric seal. In addition, the grommet body includes a plurality of inverted snaps and a larger single piece guiding surface which reduces the assembly load and provides a more accurate alignment between the drain grommet and the hole.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an air conditioning system including the drain grommet in accordance with the present disclosure assembled within a vehicle;

FIG. 2 is a perspective view of the drain grommet in accordance with the present invention;

FIG. 3 is a side cross-sectional view of the drain grommet illustrated in FIG. 2;

FIG. 4 is a side cross-sectional view of the grommet housing produced during the first-shot of the over-mold process;

FIG. 5 is a side cross-sectional view of the drain grommet after the second-shot of the over-mold process;

FIG. 6 is a perspective view of a prior art drain grommet; and

FIG. 7 is a side cross-sectional view of the prior art drain grommet illustrated in FIG. 6.

### DETAILED DESCRIPTION

The following description is merely exemplary in nature and is not intended to limit the present disclosure, application, or uses.

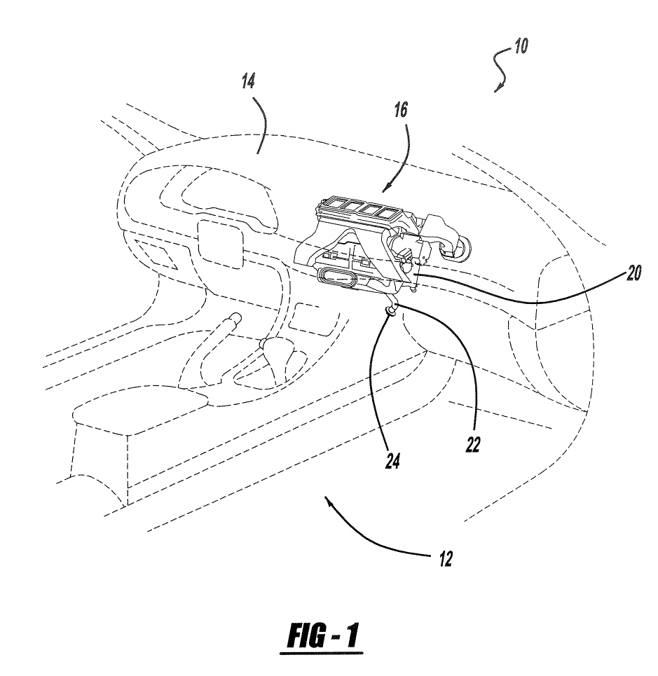

There is illustrated in FIGS. 1-3, a vehicle 10 having a passenger compartment 12, a dashboard 14 and an air conditioning unit 16. Air conditioning unit 16 is disposed behind dashboard 14 at approximately the center of passenger compartment 12 in a side-to-side direction. Air conditioning unit 16 includes a blower assembly and an air conditioning case 20. Air conditioning case 20 houses an evaporator or cooling heat exchanger of a refrigeration system, a heating heat exchanger of a heating system, temperature adjusting mechanisms and air blowing mode selecting mechanisms as is known in the art. At a lower portion of air conditioning case 20, a drain tube 22 is attached to a drain hole extending through air conditioning case 20. Drain tube 22 extends between air conditioning case 20 and a drain grommet 24 which is assembled within a hole 26 defined by a floor panel 28 of vehicle 10. Water which condenses on the evaporator within air conditioning case 20 drops to the lower portion of air conditioning case 20 where it is drained to a position outside of passenger compartment 12 using drain tube 22 and drain grommet 24.

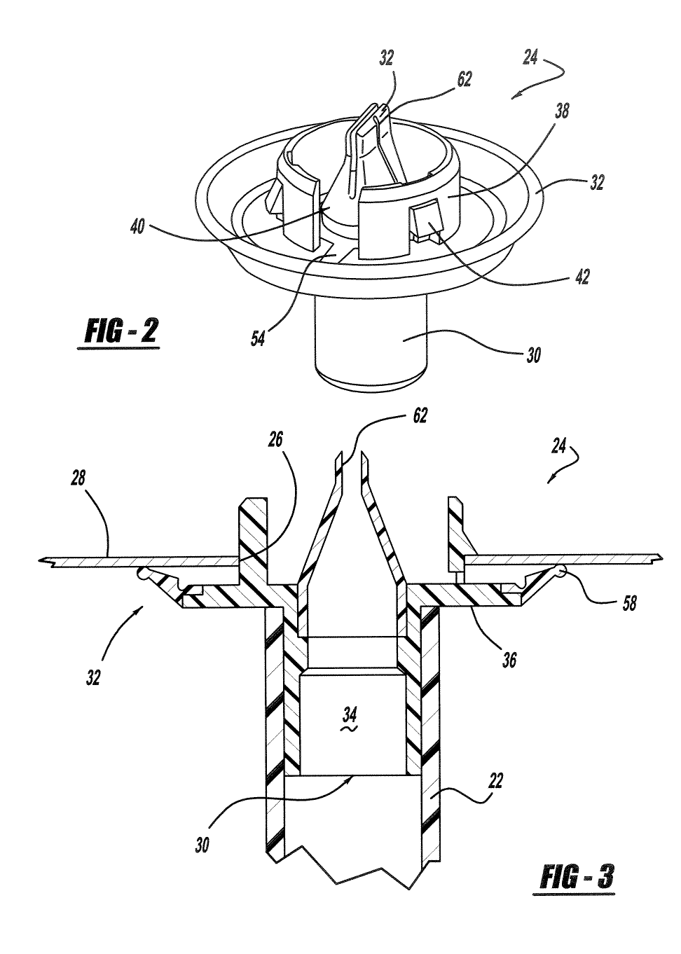

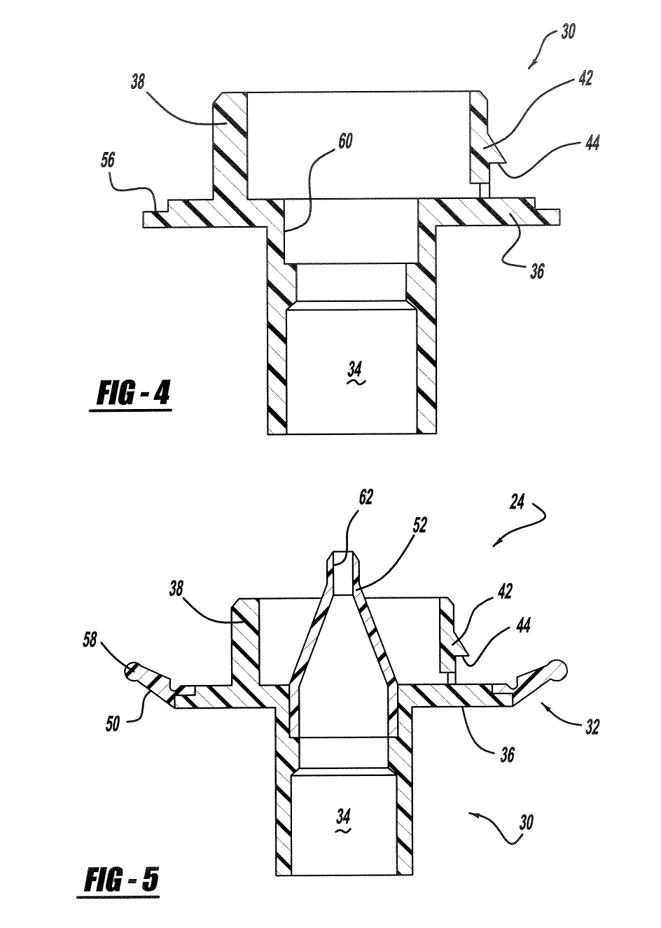

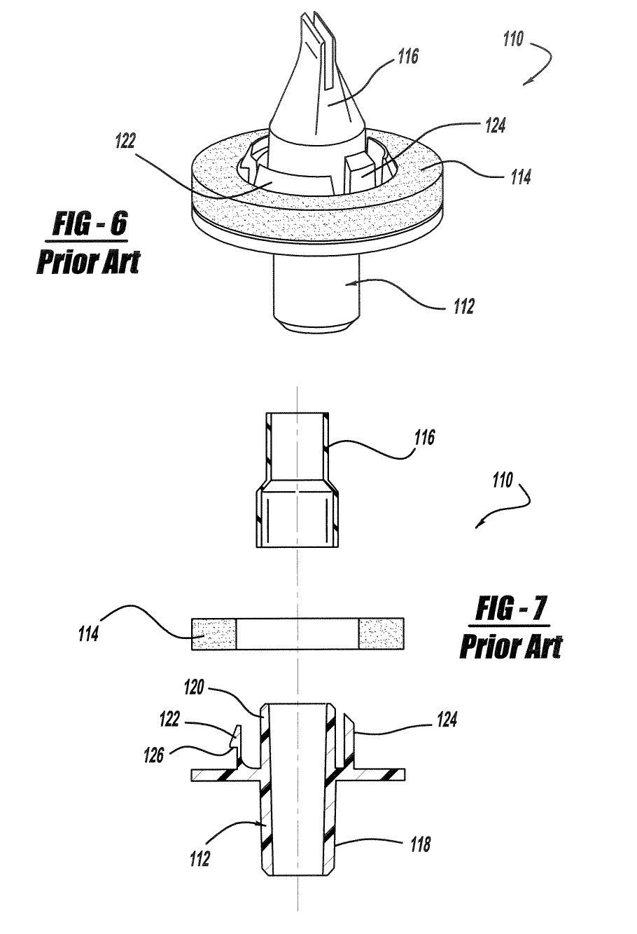

Referring now to FIGS. 2-5, drain grommet 24 is illustrated in greater detail. Drain grommet 24 comprises a grommet body 30 and an elastomeric seal assembly 32. Grommet body 30 is a molded plastic component which is molded during the first-shot of the over-mold process. Grommet body 30 includes a generally cylindrical inlet portion 34, an annular disc portion 36 and a cylindrical retention portion 38.

Cylindrical inlet portion 34 is designed to accept drain tube 22. Drain tube 22 is an elastomeric member which has an inside diameter less than the outside diameter of cylindrical inlet portion of grommet body 30 such that once drain tube 22 is assembled to cylindrical inlet portion of grommet body 30 the elasticity of drain tube 22 maintains the assembly. Annular disc portion 36 extends radially outward to provide a seat for a portion of elastomeric seal assembly 32.

Cylindrical retention portion 38 extends axially from annular disc portion 36. Cylindrical retention portion 38 is a continuous annular member having a gap 40 formed in cylindrical retention portion 38 to accommodate a portion of the forming die for drain grommet 24. Cylindrical retention portion 38 continuously extends circumferentially for more than 180° and preferably more than 270°. Cylindrical retention portion 38 acts as a guide or pilot for the assembly of drain grommet 24 into hole 26. The continuous nature of cylindrical retention portion 38 significantly reduces the potential of misalignment between drain grommet 24 and hole 26 during the assembly process. A plurality of retention members 42 each of which includes a hook portion 44 for retaining drain grommet 24 within hole 26 extend from cylindrical retention portion 38. Each retention member 42 is inverted when compared to prior art retaining snaps 122 and includes a first end distal to annular disc portion 36 which is attached to cylindrical portion 38 and a second end proximal to annular disc portion 36 which is separated from cylindrical portion 38. The assembly load of drain grommet 24 into hole 26 can be controlled by controlling the number and width of retention members 42, the thickness of material forming retention members 42, the moment arm about which retention members 42 deflect, and other design consideration for retention members 42.

Elastomeric seal assembly 32 is preferably a Santoprene® from advanced elastomeric systems rubber that is molded to grommet body 30 during the second-shot of the two-shot over-molded process. The two-step over-mold process is performed with the first shot being in Tool A and the second shot being in Tool B. Tool A and Tool B can be located in the same piece of machinery or Tool A and Tool B can be located in separate pieces of machinery with grommet body 30 being transferred between the two using robots, a human operator or by any other means known in the art. Elastomeric seal assembly 32 comprises an outer seal lip 50 and an inner duckbill seal 52 connected by a runner 54.

Outer seal lip 50 is formed into a groove 56 formed into the outer edge of annular disc portion 36. Outer seal lip 50 is a frusto-conical shaped seal having a bead 58 formed at its free end. Outer lip seal 50 is designed to have bead 58 engage floor panel 28 around hole 26 during the assembly of drain grommet 24. Outer lip seal 50 will deflect outward to provide a seal surrounding hole 26. Outer lip seal 50 replaces foam seal 114 of prior art drain grommet 110 and it reduces or eliminates issues related to assembly of the components, retention of the components, damage to the components during assembly, reliability of the components and other issues related to foam seal 114.

Duckbill seal 52 is formed into an enlarged annular portion 60 of cylindrical inlet portion 34. Runner 54 extends between outer lip seal 50 and duckbill seal 52 and is located within a radial groove formed in annular disc portion 36. Duckbill seal 52 defines a cross-shape slot 62 which allows for the drainage of water from drain tube 22 but which also prevents road noise and other external noises from being transmitted from outside the vehicle back to the passenger compartment. Duckbill seal 52 also acts as a water seal to limit the amount of water that can enter drain tube 22 through duckbill seal 52. Because duckbill seal 52 is formed within enlarged annular portion 60 of cylindrical inlet portion 34, the height above annular disc portion 36 that duckbill seal 52 extends is significantly reduced when compared to duckbill outlet 116 of drain grommet 110. The lower profile of duckbill seal 52 provides for additional clearances with other components of vehicle 10.

After drain tube 22 has been attached to drain grommet 24, drain grommet 24 is aligned with hole 26 using cylindrical retention portion 38 to align drain grommet 24 with hole 26 and keep annular disc portion 36 generally parallel with floor panel 28. Drain grommet 24 is pushed into hole 26 and each retention member 42 is deflected radially inward by the edge of floor panel 28 forming hole 26 until hook portions 44 of retention members 42 extend through hole 26. When hook portions 44 of retention members 42 extend past hole 26, retention members 42 with hook portions 44 spring radially outward and drain grommet 24 is assembled to the floor panel with outer seal lip 50 forming a seal around hole 26.

What is claimed is:

1. A drain grommet comprising:
a grommet body having a cylindrical inlet portion, an annular disc portion and a cylindrical retention portion; and
an elastomeric seal assembly having an outer lip seal and a duckbill seal.

2. The drain grommet according to claim 1, wherein the duckbill seal is disposed within an inside diameter defined by the cylindrical input portion.

3. The drain grommet according to claim 2, wherein the outer lip seal extend radially outward from the annular disc portion.

4. The drain grommet according to claim 1, wherein the outer lip seal extend radially outward from the annular disc portion.

5. The drain grommet according to claim 1, wherein the cylindrical inlet portion extend axially from a first side of the annular disc portion and the cylindrical disc portion extends axially from a second side of the annular disc portion.

6. The drain grommet according to claim 5, wherein the duckbill seal is disposed within an inside diameter defined by the cylindrical input portion.

7. The drain grommet according to claim 6, wherein the outer lip seal extend radially outward from the annular disc portion.

8. The drain grommet according to claim 5, wherein the outer lip seal extend radially outward from the annular disc portion.

9. The drain grommet according to claim 1, further comprising a plurality of hooks attached to the cylindrical retention portion.

10. The drain grommet according to claim 9, wherein each of the plurality of hooks include a first end attached to the cylindrical retention portion at a point distal from the annular disc portion and a second end separated from the cylindrical retention portion at a point proximal to the annular disc portion.

11. The drain grommet according to claim 9, wherein the duckbill seal is disposed within an inside diameter defined by the cylindrical input portion.

12. The drain grommet according to claim 12, wherein the outer lip seal extend radially outward from the annular disc portion.

13. The drain grommet according to claim 9, wherein the outer lip seal extend radially outward from the annular disc portion.

14. The drain grommet according to claim 1, wherein the cylindrical retention portion extends continuously for greater than 180°.

15. The drain grommet according to claim 14, further comprising a plurality of hooks attached to the cylindrical retention portion.

16. The drain grommet according to claim 15, wherein each of the plurality of hooks include a first end attached to the cylindrical retention portion at a point distal from the annular disc portion and a second end separated from the cylindrical retention portion at a point proximal to the annular disc portion.

17. The drain grommet according to claim 14, wherein the duckbill seal is disposed within an inside diameter defined by the cylindrical input portion.

18. The drain grommet according to claim 17, wherein the outer lip seal extend radially outward from the annular disc portion.

19. The drain grommet according to claim 14, wherein the outer lip seal extend radially outward from the annular disc portion.

20. The drain grommet according to claim 1, manufactured using a two-step over-mold process using two molds.
